(19) United States
(12) Patent Application Publication
(10) Pub. No.: US 2018/0077242 A1
(43) Pub. Date: Mar. 15, 2018

(54) NETWORK COMMUNICATION TECHNOLOGIES FOR LABORATORY INSTRUMENTS

(71) Applicants: Andrew Henry Carl, Cincinnati, OH (US); Olivier Lemaitre, Cincinnati, OH (US)

(72) Inventors: Andrew Henry Carl, Cincinnati, OH (US); Olivier Lemaitre, Cincinnati, OH (US)

(21) Appl. No.: 15/694,487

(22) Filed: Sep. 1, 2017

Related U.S. Application Data
(60) Provisional application No. 62/385,491, filed on Sep. 9, 2016.

(51) Int. Cl. H04L 29/08; H04L 12/24

(52) U.S. Cl. CPC H04L 67/12; H04L 41/0233; H04L 67/16; H04L 67/02

(57) ABSTRACT

Embodiments include a network communication apparatus for laboratory instruments according to one or more of the inventive principles as shown and described herein. Embodiments can include a system for enabling remote network communications to/from instruments in a laboratory with one or more instrument communication devices (ICDs), one or more laboratory instruments, an instrument connection (IC) server, and one or more remote computing devices.

### REFERENCE TO RELATED APPLICATION

The present application is a U.S. non-provisional application that claims the priority benefit of U.S. provisional patent application Ser. No. 62/385,491, filed Sep. 9, 2016, and hereby incorporates the same application by reference in its entirety.

### TECHNICAL FIELD

Embodiments of the technologies described herein relate, in general, to controlling and monitoring laboratory instruments. More particularly, the technologies described herein relate to enabling network communications between laboratory instruments and remote computing devices.

### BRIEF DESCRIPTION OF THE DRAWINGS

It is believed that certain embodiments will be better understood from the following description taken in conjunction with the accompanying drawings, in which like references indicate similar elements and in which:

FIG. 1 is a simplified block diagram of at least one embodiment of a system for enabling network communications between laboratory instruments and remote computing devices;

FIG. 2 is a simplified block diagram showing at least one illustrative network configuration that can be utilized by the computing devices of FIG. 1 to enable network communications between laboratory instruments and remote computing devices;

FIG. 3 is a simplified block diagram of at least one embodiment of the instrument communication device(s) of FIGS. 1 and 2;

FIG. 4 is a simplified flow diagram of at least one embodiment of a method that may be executed by the instrument communication device(s) of FIGS. 1 and 2 during initialization of a virtual machine and establishment of a WebSocket connection;

FIG. 5 is a simplified flow diagram of at least one alternative embodiment of a method that may be executed by the instrument communication device(s) of FIGS. 1 and 2 during initialization of a virtual machine and establishment of a WebSocket connection;

FIG. 6 is a simplified flow diagram of at least one embodiment of a method that may be executed by the instrument communication device(s) of FIGS. 1 and 2 for receiving and forwarding network packets between the laboratory instrument and the virtual machine; and

FIG. 7 is a simplified flow diagram of at least one embodiment of a method that may be executed by the virtual machine(s) of FIGS. 1 and 2 during initialization and establishment of a WebSocket connection with the instrument communication device(s); and

FIG. 8 is a simplified flow diagram of at least one alternative embodiment of a method that may be executed by the virtual machine(s) of FIGS. 1 and 2 during initialization and establishment of a WebSocket connection with the instrument communication device(s).

### DETAILED DESCRIPTION

Various non-limiting embodiments of the present disclosure will now be described to provide an overall understanding of the principles of the structure, function, and use of systems and methods disclosed herein. One or more examples of these non-limiting embodiments are illustrated in the selected examples disclosed and described in detail with reference made to the figures in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. In addition, elements illustrated in the figures are not necessarily drawn to scale for simplicity and clarity of illustration. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware.

The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

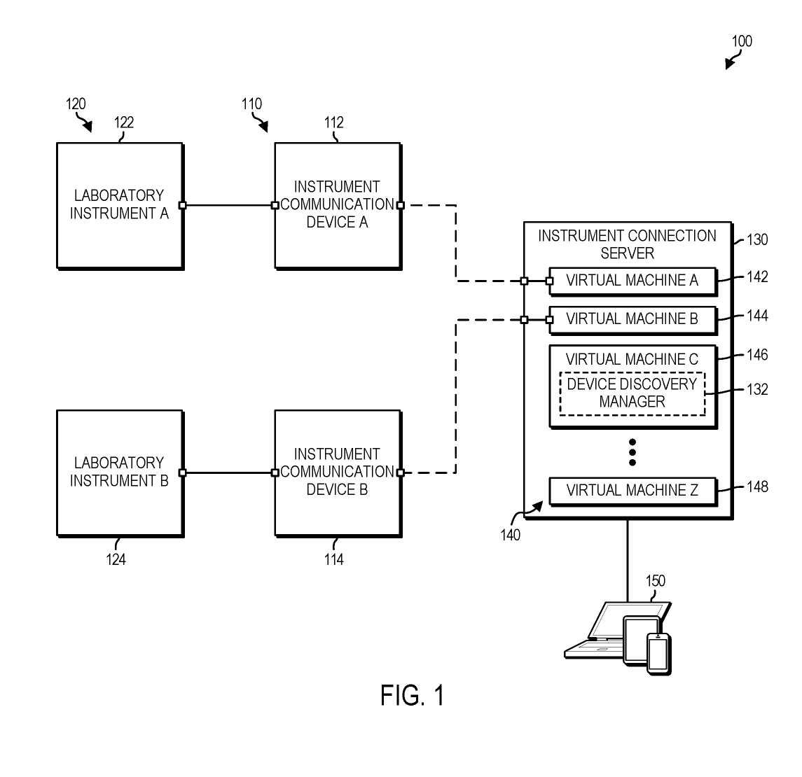

Referring now to FIGS. 1-3, in one embodiment, a system 100 for enabling remote network communications to/from instruments in a laboratory includes one or more instrument communication devices (ICDs) 110, one or more laboratory instruments 120, an instrument connection (IC) server 130, and one or more remote computing devices 150. As illustratively shown, the system 100 includes multiple ICDs 110 (e.g., the instrument communication device (ICD) 112 and the ICD 114). Each ICD 110 is communicatively coupled to a separate laboratory instrument 120 (e.g., the instrument 122 and the instrument 124). Additionally, each ICD 110 is communicatively coupled to a different virtual machine 140 (e.g., the virtual machine 142 and the virtual machine 144) executed by the IC server 130. In the illustrative embodiment, the ICD 112 and the ICD 114 are communicatively coupled to the virtual machine 142 and the virtual machine 144 via wireless communication channels. Additionally, in some embodiments, the system includes a device discovery manager 132, the functionality of which can be provided by a virtual machine 140 (e.g., the virtual machine 146) executed by the IC server 130. It should be appreciated that although the system 100 is illustratively shown as including two ICDs 110, two laboratory instruments 120, and four virtual machines 140, the system 100 can include fewer or more of these devices/components in other embodiments.

In operation, the IC server 130 initializes one or more virtual machines 140. For example, in the illustrative embodiment, the IC server 130 initializes a separate virtual machine 140 (e.g., the virtual machine 142 and the virtual machine 144) for each piece of laboratory equipment 120 to be accessed via the system 100. In some embodiments, the virtual machine 142 and the virtual machine 144 (or any number of other virtual machines 140) each execute an operating system such as, for example, WINDOWS. It should be appreciated, however, that the virtual machines 140 can execute any other type of operating system in other embodiments.

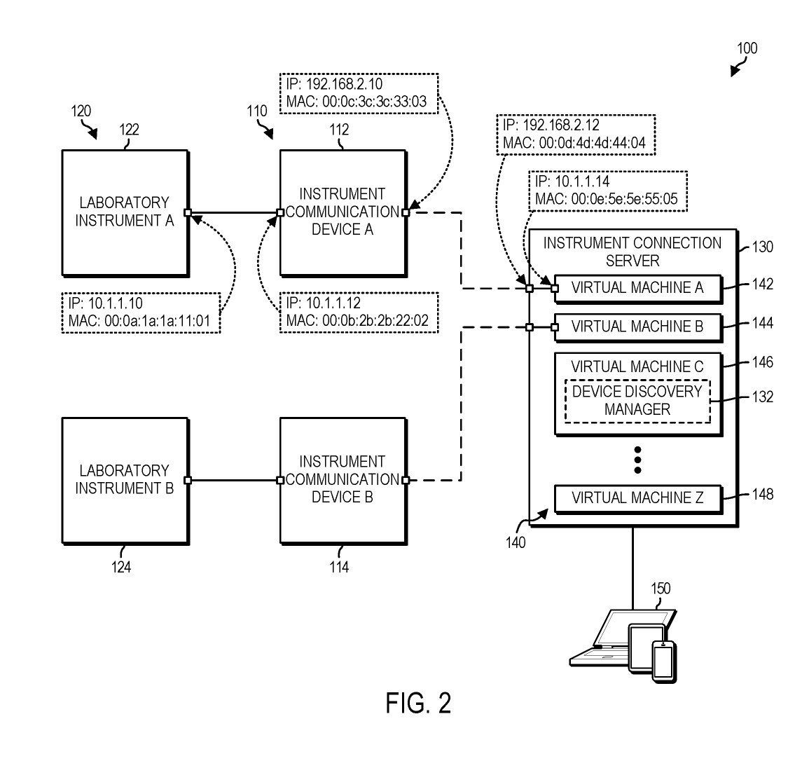

In some embodiments, the virtual machines 140 are each configured to generate and broadcast a discovery message over one or more networks (e.g., wired or wireless networks) during initialization. For example, the virtual machines 140 (e.g., the virtual machines 142, 144, 148 illustratively shown in FIGS. 1-2) can each be configured to broadcast a discovery message over one or more wireless networks via one or more wireless network interfaces of the IC server 130. Such wireless network(s) can communicatively couple one or more of the ICDs 110 to the wireless network interface(s) of the IC server 130. In an illustrative embodiment, each of the ICDs 110 of the system 100, when active, are configured to respond to the discovery device messages broadcasted by the virtual machines 140. To do so, the ICDs 110 can include an agent or other mechanism for receiving, identifying, and responding to the broadcasted discovery message from the virtual machines 140. The response messages generated and transmitted by the active ICDs 110 of the system 100 may include connection information and identification data (e.g., Internet Protocol (IP) addresses, media access control (MAC) addresses, device identifiers, etc.). For example, the response messages generated by the ICD 112 can include data that uniquely identifies the ICD 112 (e.g., a unique name, a serial number, etc.), an IP address and a MAC address of a wired network interface of the ICD 112, an IP address and a MAC address of a wireless network interface of the ICD 112, an IP address and a MAC address of a wired network interface of the laboratory instrument 120 (e.g., the laboratory instrument 122) directly connected to the ICD 112, and/or any other type of data describing or associated with the ICD 112 and/or the connected laboratory instrument 122.

Based on the connection information and identification data received from the ICDs 110 in response to broadcasted discovery messages, the IC server 130 (or a boot module or process of the particular virtual machine 140 being initialized) generates one or more virtual network adapters, each being configured to access a specific laboratory instrument 120. For example, during initialization of the virtual machine 142, a virtual network adapter can be created to enable communications with the laboratory instrument 122. In such example, the virtual network adapter can be preconfigured with an IP address (or with any other type of network configuration information) compatible for communications with the laboratory instrument 122. In some embodiments, the virtual machine 140 can generate one or more static routes configured to route and/or forward network packets originating from modules or software (e.g., instrument monitoring software, analysis software, etc.) executing on the virtual machine 140 to the virtual network adapter. In embodiments in which the IC server 130 and/or the boot module of the virtual machine 140 being initialized receives connection information and identification data from multiple ICDs 110 active (e.g., initialized, deployed, etc.) in the system 100, the IC server 130 and/or the boot module of the virtual machine 140 being initialized may be configured to receive user input data identifying the target ICD 110 (e.g., the ICD 112) and laboratory instrument 120 (e.g., the laboratory instrument 122) communicatively coupled thereto. In response to receiving such data, the IC server 130 and/or the boot module of the virtual machine 140 being initialized may be configured to only generate a virtual network adapter configured to access the target laboratory instrument 120 (e.g., the laboratory instrument 122) via the target ICD 110 (e.g., the ICD 112) communicatively coupled thereto.

In embodiments in which the system 100 includes the device discovery manager 132, the virtual machines 140 (e.g., the virtual machines 142, 144, 148) are configured to query (e.g., transmit a request message, etc.) the device discovery manager 132 during initialization. In such embodiments, the device discovery manager 132 includes connection and identification information (e.g., Internet Protocol (IP) addresses, media access control (MAC) addresses, device identifiers, etc.) corresponding to each of the ICDs 110, the virtual machines 140, and the laboratory instruments 120. In such embodiments, the IC server 130 (or a boot module or process of the virtual machine 140 being initialized) generates the virtual network adapter configured to access the specific laboratory instrument 120 based on the connection information and identification data received from the device discovery manager 132. For example, during initialization of the virtual machine 142, a virtual network adapter can be created to enable communications with the laboratory instrument 122 based on the connection and identification information received from the device discovery manager 132. As discussed herein, the virtual network adapter can be preconfigured with an IP address (or with any other type of network configuration information) compatible for communications with the laboratory instrument 122.

In an illustrative embodiment, each of the virtual machines 140 establishes a WebSocket connection with a different one of the ICDs 110 upon initialization. For example, upon initialization, a virtual machine 140 can establish a WebSocket connection with an ICD 110, which is communicatively coupled to a laboratory instrument 120. To do so, the virtual machine 140 can transmit a WebSocket connection request message to the ICD 110, which in response can transmit a WebSocket response message to the virtual machine 140 to complete establishment of the WebSocket connection. The WebSocket connections can be used in part to facilitate transmitting network packets between the laboratory instruments 120 and the virtual machines 140 and, more specifically, the instrument monitoring and analysis software executing thereon. To do so, network packets generated by a laboratory instrument 120 can be received by an ICD 110 communicatively coupled thereto via a wired network interface of the ICD 110. The ICD 110 can package or format the received networks as JSON objects (or as any other type of object or in any other message format). Thereafter, the ICD 110 can transmit the JSON objects to the virtual network adapter of the virtual machine 140 via the established WebSocket connection. Upon receipt, the virtual machine 140 (or the virtual network adapter of the virtual machine 140) can unpack or otherwise extract the original network packet from the JSON object and forward the network packet to the virtual machine 140 and ultimately to the instrument monitoring and analysis software executing thereon. Additionally, network packets generated by the instrument monitoring and analysis software executing on the virtual machine 140 can be packaged or formatted as JSON objects (or as any other type of object or in any other message format) by a component or module of the virtual machine 140 such as, for example, the virtual network adapter of the virtual machine 140. Thereafter, the JSON objects containing the network packets generated by the virtual machine 140 can be transmitted to the ICD 110 via the established WebSocket connection. Upon receipt, the ICD 110 can unpack or otherwise extract the original network packet from the JSON object and forward the network packet to the laboratory instrument 120 communicatively coupled thereto via a wired network interface of the ICD 110.

In some embodiments, an ICD 110 can modify (e.g., replace, spoof, substitute, etc.) the IP and/or MAC addresses of network packets that are to be forwarded to a connected laboratory instrument 120 and/or a virtual machine 140. For example, as illustratively shown in FIG. 1, the ICD 112 is configured receive network packets from the laboratory instrument 122 via a wired network interface of the ICD 112 and forward those network packets to the virtual machine 142 via a wireless network interface of the ICD 112. Prior to forwarding the network packets to the virtual machine 142 via the wireless network interface, the ICD 112 may be configured to spoof the source MAC address and/or the source IP address of the network packets to include the MAC and/or IP addresses of the wired network interface of the ICD 112 rather than the MAC and/or IP addresses of the network interface of the laboratory instrument 122. In another example, the ICD 112 is configured receive network packets from the virtual machine 142 (and/or any instrument monitoring and analysis software executing thereon) via the wireless network interface of the ICD 112 and the previously established WebSocket connection, and forward those network packets to the laboratory instrument 122 via the wired network interface of the ICD 112. Prior to forwarding the network packets to the laboratory instrument 122 via the wired network interface, the ICD 112 may be configured to replace the destination MAC address and/or the destination IP address of the network packets to include the MAC and/or IP addresses of the laboratory instrument 122 rather than the MAC and/or IP addresses of the wired wireless network interface of the ICD 112. It should be appreciated that by spoofing and replacing the source and destination MAC and/or IP addresses of the network packets received and forwarded by the ICD 112, it appears to the laboratory instrument 122 and the virtual machine 142 that the network packets were directly transmitted (e.g., without being forwarded by the ICD 112).

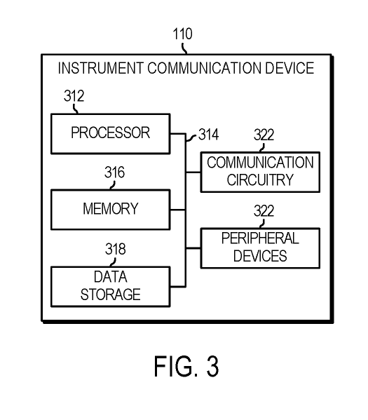

The ICD 110 (or each ICD 110 if multiple ICDs 110 are included in the system 100) can be embodied as any type of computing device or server capable of processing, communicating, storing, maintaining, and transferring data. For example, the ICD 110 can be embodied as a microcomputer, a minicomputer, a custom chip, an embedded processing device, a mobile computing device, a laptop computer, a handheld computer, a smart phone, a tablet computer, a personal digital assistant, a telephony device, a desktop computer, a mainframe, or other computing device and/or suitable programmable device. In some embodiments, the ICD 110 can be embodied as a computing device integrated with other systems or subsystems. As illustratively shown in FIG. 3, the ICD 110 includes a processor 312, a system bus 314, a memory 316, a data storage 318, communication circuitry 320, and one or more peripheral devices 322. Of course, the ICD 110 can include other or additional components, such as those commonly found in a server and/or computer (e.g., various input/output devices), in other embodiments. Additionally, in some embodiments, one or more of the illustrative components can be incorporated in, or otherwise from a portion of, another component. For example, the memory 316, or portions thereof, can be incorporated in the processor 312 in some embodiments. Furthermore, it should be appreciated that the ICD 110 can include other components, sub-components, and devices commonly found in a computer and/or computing device, which are not illustrated in FIG. 3 for clarity of the description.

The processor 312 can be embodied as any type of processor capable of performing the functions described herein. For example, the processor 312 can be embodied as a single or multi-core processor, a digital signal processor, a microcontroller, a general purpose central processing unit (CPU), a reduced instruction set computer (RISC) processor, a processor having a pipeline, a complex instruction set computer (CISC) processor, an application specific integrated circuit (ASIC), a programmable logic device (PLD), a field programmable gate array (FPGA), or any other type of processor or processing/controlling circuit or controller.

In various configurations, the ICD 110 includes a system bus 314 for interconnecting the various components of the ICD 110. The system bus 314 can be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations with the processor 312, the memory 316, and other components of the ICD 110. In some embodiments, the ICD 110 can be integrated into one or more chips such as a programmable logic device or an application specific integrated circuit (ASIC). In such embodiments, the system bus 314 can form a portion of a system-on-a-chip (SoC) and be incorporated, along with the processor 312, the memory 316, and other components of the ICD 110, on a single integrated circuit chip.

The memory 316 can be embodied as any type of volatile or non-volatile memory or data storage capable of performing the functions described herein. For example, the memory 316 can be embodied as read only memory (ROM), random access memory (RAM), cache memory associated with the processor 312, or other memories such as dynamic RAM (DRAM), static RAM (SRAM), programmable ROM (PROM), electrically erasable PROM (EEPROM), flash memory, a removable memory card or disk, a solid state drive, and so forth. In operation, the memory 316 can store various data and software used during operation of the ICD 110 such as operating systems, applications, programs, libraries, and drivers.

The data storage 318 can be embodied as any type of device or devices configured for short-term or long-term storage of data such as, for example, memory devices and circuits, memory cards, hard disk drives, solid-state drives, or other data storage devices. For example, in some embodiments, the data storage 318 includes storage media such as a storage device that can be configured to have multiple modules, such as magnetic disk drives, floppy drives, tape drives, hard drives, optical drives and media, magneto-optical drives and media, Compact Disc (CD) drives, Compact Disc Read Only Memory (CD-ROM), Compact Disc Recordable (CD-R), Compact Disc Rewriteable (CD-RW), a suitable type of Digital Versatile Disc (DVD) or Blu-Ray disc, and so forth. Storage media such as flash drives, solid state hard drives, redundant array of individual disks (RAID), virtual drives, networked drives and other memory means including storage media on the processor 312, or the memory 316 are also contemplated as storage devices. It should be appreciated that such memory can be internal or external with respect to operation of the disclosed embodiments. It should also be appreciated that certain portions of the processes described herein can be performed using instructions stored on a computer-readable medium or media that direct or otherwise instruct a computer system to perform the process steps. Non-transitory computer-readable media, as used herein, comprises all computer-readable media except for transitory, propagating signals.

The communication circuitry 320 of the ICD 110 may be embodied as any type of communication circuit, device, interface, or collection thereof, capable of enabling communications between the ICD 110 and the laboratory instruments 120, the IC server 130, the virtual machines 140 executed by the IC server 130, and/or any other computing devices communicatively coupled thereto. For example, the communication circuitry 320 may be embodied as one or more network interface controllers (NICs), in some embodiments. The communication circuitry 320 may be configured to use any one or more communication technologies (e.g., wireless or wired communications) and associated protocols (e.g., Ethernet, WiMAX, etc.) to effect such communication. In the illustrative embodiment, the communication circuitry 320 includes a wired communication interface (e.g., Ethernet, coaxial communication interface, USB, serial communication interface, parallel communication interface, etc.) configured to enable communications directly between the ICD 110 and the laboratory instrument 120 via a physical communication connection. In such embodiment, the communication circuitry 320 also includes a wireless communication interface (e.g., Wi-Fi®, Bluetooth®, mesh network, etc.) configured to enable communications between the ICD 110 and the IC server 130 and/or the virtual machines 140 executed by the IC server 130.

In some embodiments, the ICD 110, the laboratory instruments 120, the IC server 130, the virtual machines 140 executed by the IC server 130, the remote computing device(s) 150, and/or any other computing devices of the system 100, can communicate with each other over one or more networks. The network(s) can be embodied as any number of various wired and/or wireless communication networks. For example, the network(s) can be embodied as or otherwise include a local area network (LAN), a wide area network (WAN), a cellular network, or a publicly-accessible, global network such as the Internet. Additionally, the network(s) can include any number of additional devices to facilitate communication between the computing devices of the system 100.

Additionally, in some embodiments, the ICD 110 can further include one or more peripheral devices 322. Such peripheral devices 322 can include any type of peripheral device commonly found in a computing device such as additional data storage, speakers, a hardware keyboard, a keypad, a gesture or graphical input device, a motion input device, a touchscreen interface, one or more displays, an audio unit, a voice recognition unit, a vibratory device, a computer mouse, a peripheral communication device, and any other suitable user interface, input/output device, and/or other peripheral device.

Referring back to FIG. 1, the laboratory instruments 120 can be any type of instruments or devices used in a laboratory or testing facility. As such, the laboratory instruments 120 may include devices and structures commonly found in analysis and testing devices, which are not shown in FIG. 1 for clarity of the description. It should be appreciated that the present disclosure is not limited to the use of laboratory instruments 120 in laboratory or testing environments. As such, the system 100 and/or any of the components or devices thereof can be used with any other type of equipment or device in any other type environment. For example, in some embodiments, the system 100 and/or any of the components or devices thereof can be used to remotely monitor and control machines or devices used in a manufacturing process.

The IC server 130 may be embodied as any type of computing device capable of performing the functions described herein. As such, the IC server 130 may include devices and structures commonly found in computing devices such as processors, memory devices, communication circuitry, and data storages, which are not shown in FIG. 1 for clarity of the description. The IC server 130 is configured to initialize and execute one or more virtual machines 140. Each virtual machine 140 executes an operating system such as, for example, WINDOWS. It should be appreciated, however, that the virtual machines 140 can execute any other type of operating system in other embodiments. Additionally, each virtual machine 140 can execute proprietary and/or open source instrument control and analysis software and/or tools configured to access and/or control the one or more of the laboratory instruments 120. To do so, virtual network adapters created for each virtual machine 140 can be configured to access a specific that is ICD 110 communicatively coupled to a particular laboratory instrument 120. In some illustrative embodiments, the virtual network adapters, or the software device drivers and/or protocols defined therefore, can be configured to transmit network packets originating from the virtual machines 140 to one or more ICDs 110 via separate WebSocket connections. Additionally or alternatively, the virtual network adapters, or the software device drivers and/or protocols defined therefore, can be configured to receive network packets from the ICDs 110 via the separate WebSocket connections. In either case, the network packets can be packaged and/or formatted as JSON objects (or in any other format) prior to transmission via the WebSocket connections.

Additionally, as discussed herein, the ICD 110 is configured to control communications between the laboratory instrument 120 and a specific virtual machine 140 executed by the IC server 130. Additionally, the IC server 130 and/or each of the virtual machines 140 can be configured to provide user access control services. For example, the IC server 130 and/or the virtual machines 140 can be configured to control which laboratory instruments 120, if any, a particular user is permitted to access. In another example, the IC server 130 and/or the virtual machines 140 can be configured to control when (e.g., during a shift, within a time range, etc.) or how often a user is permitted to access one or more of the laboratory instruments 120.

In some embodiments, the IC server 130 also initializes and executes a virtual machine 146 configured to provide device discovery services for the system 100 (e.g., the device discovery manager 132). The device discovery manager 132 can be configured to manage or otherwise store connection and identification information (e.g., Internet Protocol (IP) addresses, media access control (MAC) addresses, device identifiers, etc.) corresponding to each of the ICDs 110, the virtual machines 140, and the laboratory instruments 120. In such embodiments, the device discovery manager 132 is configured to receive connection and identification information from each ICD 110. Additionally, the device discovery manager 132 may be configured to respond to queries received from the IC server 130 and/or a virtual machine 140 during initialization. Such responses include connection and identification information that is used to generate a virtual network adapter for the virtual machine 140 being initialized. It should be appreciated that the discovery services of the device discovery manager 132 advantageously provide an added layer of security to the system 100. More specifically, without the use of the device discovery manager 132, it would difficult for unauthorized individuals to learn of and subsequently access the ICDs 110 of the system 100.

The remote computing devices 150 may be embodied as any type of computing devices capable of performing the functions described herein. As such, the remote computing devices 150 may include devices and structures commonly found in computing devices such as processors, memory devices, communication circuitry, and data storages, which are not shown in FIG. 1 for clarity of the description. In some embodiments, the remote computing devices 150 are configured to enable a user to interact with the laboratory equipment 120 via the IC server 130. For example, the remote computing devices 150 may be configured to access a virtual machine 140 executed by the IC server 130 via a remote desktop connection. In other embodiments, the remote computing devices 150 may be configured to access a virtual machine 140 executed by the IC server 130 via a Virtual Network Computing (VNC) connection or any other type of remote desktop sharing communication channel or protocol. As discussed herein, the virtual machine 140 may be configured to execute proprietary and/or open source instrument control and analysis software and/or tools suitable for accessing and/or controlling one or more of the laboratory instruments 120. Since the remote computing devices 150 access the IC server 130 in the illustrative embodiments, user access control and/or test run schedule control can be provided.

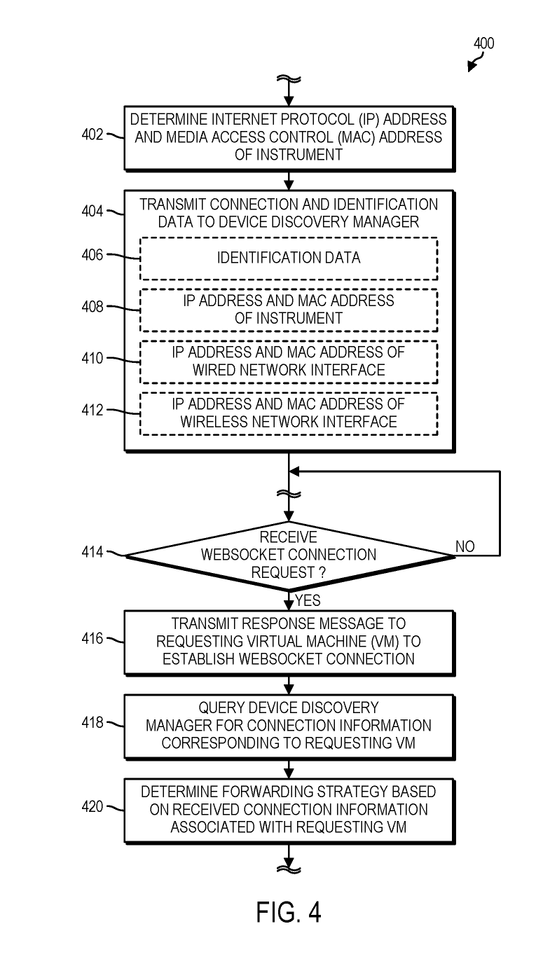

Referring now to FIG. 4, a method 400 that may be executed by the ICDs 110 for establishing a WebSocket connection during initialization of a virtual machine 140 is illustratively shown. For simplicity, the following description is directed to the establishment of a WebSocket connection between the ICD 112 and the virtual machine 142 for enabling remote control and monitoring of the laboratory instrument 122. It should be appreciated, however, that the method 400 can be executed by any other ICD 110 for establishing a WebSocket connection between any other virtual machine 140 to enable remote control and monitoring of any other laboratory instrument 120. The method 400 begins with block 402 in which the ICD 112 determines the IP address and MAC address of the laboratory instrument 122 communicatively coupled thereto via a physical communication medium such as, for example, an Ethernet cable.

In block 404, the ICD 112 transmits connection information and identification data to the device discovery manager 132 executed by the virtual machine 146 (or any other virtual machine 140 of the IC server 130) via a wireless communication channel. The wireless communication channel can be established between the ICD 112 and a wireless network interface of the IC server 130 accessible to the virtual machine 146 executing the device discovery manager 132. The connection information and identification data can include data that uniquely identifies the ICD 112 (e.g., a unique name, a serial number, etc.) to the device discovery manger 132 (block 406). The connection information and identification data can also include the IP and MAC addresses of the laboratory instrument 122 directly connected to the ICD 112 (block 408). Additionally, the connection information and identification data can also include the IP and MAC addresses of the wired and wireless communication interfaces of the ICD 112 (block 410 and block 412). It should be appreciated that the connection information and identification data can include any other type of data describing or associated with the ICD 112 and/or the laboratory instrument 122.

In decision block 414, the ICD 112 determines whether a WebSocket connection request message is received from the virtual machine 142. In some embodiments, the WebSocket connection request message may be generated by the virtual machine 142 during initialization. If, in decision block 414, the ICD 112 determines that a WebSocket connection request message is received, the method 400 advances to block 416. If, however, the ICD 112 determines instead that a WebSocket connection request message is not received, the method 400 loops back to decision block 414 and the ICD 112 continues monitoring for receipt of WebSocket connection request message from the virtual machine 142.

In block 416, the ICD 112 transmits a WebSocket response message to the virtual machine 142 that transmitted the original WebSocket connection request message. It should be appreciated that upon receipt of the WebSocket response message, the virtual machine 142 can establish a WebSocket connection with the ICD 112. In some embodiments, the WebSocket connection between the ICD 112 and the virtual machine 142 can be maintained while the virtual machine 142 is being executed by the IC server 130. In other embodiments, the WebSocket connection can be terminated or torn down after a predefined or reference time interval.

As discussed herein, the ICD 112 and the virtual machine 142 are configured to utilize the WebSocket connection to facilitate transmitting network packets between the laboratory instrument 122 and the virtual machine 142 (or the software executing thereon). For example, in the illustrative embodiment, the ICD 112 is configured to receive network packets that originate from the laboratory instrument 122 via a wired network interface of the ICD 112, format those packets as JSON objects (or as any other type of object or according to any other message format), and wirelessly transmit the JSON objects to the virtual machine 142 (or the software executing thereon) via the WebSocket connection and a wireless network interface of the ICD 112. Additionally, in the illustrative embodiment, the ICD 112 is configured to wirelessly receive network packets formatted as JSON objects from the virtual machine 142 (or the software executing thereon) via the WebSocket connection and the wireless network interface of the ICD 112, extract the network packets from the received JSON objects, and transmit the extracted network packets to the laboratory instrument 122 via the wired network interface of the ICD 112.

In block 418, the ICD 112 queries the device discovery manager 132 for connection information corresponding to the virtual machine 142. To do so, in some embodiments, the ICD 112 can transmit a message to the device discovery manager 132 requesting the IP address and MAC address of a virtual network adapter generated for the virtual machine 142 during initialization. In some embodiments, the request message transmitted to the device discovery manager 132 may include a request for the IP and MAC addresses of a wireless network interface of the IC server 130 accessible to the virtual machine 142. Additionally, the request message can include a request for the IP address and MAC address of the specific laboratory instrument 122 to be accessed.

In block 420, the ICD 112 determines a forwarding strategy based on the IP and MAC address information received from the device discovery manager 132 in response to the transmitted request message. To do so, in some embodiments, the ICD 112 may determine to spoof the source MAC and/or source IP addresses of network packets to be forwarded to the laboratory instrument 122 with the IP and/or MAC addresses of the wired network interface of the ICD 112. In doing so, it will appear to the laboratory instrument 122 that the network packets originated from the wired network interface of the ICD 112 and, as a result, response network packets should be sent to the MAC address and/or IP address of the wired network interface of the ICD 112. In other embodiments, the ICD 112 may determine to replace the destination MAC and/or destination IP addresses of network packets to be forwarded to the virtual machine 142 with the MAC address and/or IP address of the virtual network adapter of the virtual machine 142. For example, in embodiments in which the ICD 112 receives a JSON object via the WebSocket connection that contains a network packet originating from the virtual machine 142 (or the software executing thereon), the ICD 112 extracts the network packet from the received JSON object. Prior to being transmitted to the laboratory instrument 122, the ICD 112 may spoof the source MAC address and/or the source IP address of the network packet to include the MAC and/or IP addresses of the wired network interface of the ICD 112 rather than the MAC and/or IP addresses of the virtual machine 142 (or the virtual network adapter generated therefore). Additionally, in embodiments in which the ICD 112 receives a network packet originating from the laboratory instrument 122, the ICD 112 packages the received network packet as a JSON object for transmission to the virtual machine 142 (or the software executing thereon) and/or the virtual network adapter of the virtual machine 142 via the WebSocket connection. In such embodiments, prior to creation of the JSON object and/or prior to transmission of the JSON object to the virtual machine 142, the ICD 112 may replace the destination MAC and/or destination IP addresses of the network packet packaged (or to be packaged) within the JSON object to include the MAC and/or IP addresses of the virtual machine 142 (or the virtual network adapter generated therefore).

Referring now to FIG. 2, an illustrative example of spoofing and replacing MAC and/or IP addresses is depicted. As shown, the laboratory instrument 122 can be associated with an IP address of 10.1.1.10 and a MAC address of 00:0a:1a:1a:11:01. The wired interface of the ICD 112 can be associated with an IP address of 10.1.1.12 and a MAC address of 00:0b:2b:2b:22:02. The wireless network interface of the ICD 112 can be associated with an IP address of 192.168.2.10 and a MAC address of 00:0c:3c:3c:33:03. The wireless network interface of the IC server 130 can be associated with an IP address of 192.168.2.12 and a MAC address of 00:0d:4d:4d:44:04. Additionally, the virtual network adapter generated for the virtual machine 142 can be associated with an IP address of 10.1.1.14 and a MAC address of 00:0e:5e:55:05. Continuing with this example, the ICD 112 may determine to forward network packets received from the virtual machine 142 (via instrument monitoring and analysis software executing thereon) to the laboratory instrument 122. In doing so, the ICD 112 may, in some embodiments, determine to spoof the source IP and/or source MAC addresses of the network packets to be forwarded to the laboratory instrument 122 to include a source IP address of 10.1.1.12 and/or a source MAC address of 00:0b:2b:2b:22:02 (i.e., the IP and/or MAC addresses of wired network interface of the ICD 112) rather than a source IP address of 10.1.1.14 and/or a source MAC address of 00:0e:5e:5e:55:05 (i.e., the IP and MAC addresses of the virtual network adapter of the virtual machine 142). In doing so, it will appear to the laboratory instrument 122 that the forwarded network packet was directly sent by the virtual machine 142. Additionally, the laboratory instrument 122 can utilize the spoofed source MAC and/or source IP addresses of the received network packet to determine where to send subsequent response network packets. The ICD 112 may also determine to forward network packets received from the laboratory instrument 122 to the virtual machine 142 and/or the instrument monitoring and analysis software executing thereon. In doing so, the ICD 112 may, in some embodiments, determine to replace the destination IP and/or MAC addresses of the network packets to be forwarded to the virtual machine 142 to include a destination IP address of 10.1.1.14 and/or a destination MAC address of 00:0e:5e:5e:55:05 (i.e., the IP and/or MAC addresses of the virtual network adapter of the virtual machine 142). In doing so, it will appear to the virtual machine 142 (and/or the instrument monitoring and analysis software executing thereon) that the forwarded network packet was directly sent by the laboratory instrument 122.

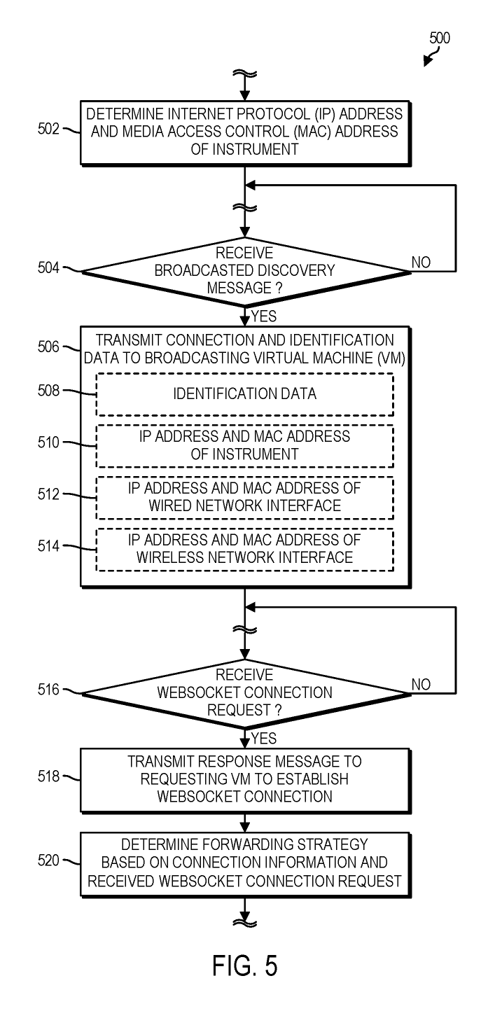

Referring now to FIG. 5, another method 500 that may be executed by the ICDs 110 for establishing a WebSocket connection during initialization of a virtual machine 140 is illustratively shown. For simplicity, the following description is directed to the establishment of a WebSocket connection between the ICD 112 and the virtual machine 142 for enabling remote control and monitoring of the laboratory instrument 122. It should be appreciated, however, that the method 500 can be executed by any other ICD 110 for establishing a WebSocket connection between any other virtual machine 140 to enable remote control and monitoring of any other laboratory instrument 120. The method 500 begins with block 502 in which the ICD 112 determines the IP address and MAC address of the laboratory instrument 122 communicatively coupled thereto via a physical communication medium such as, for example, an Ethernet cable.

In decision block 504, the ICD 112 determines whether a discovery message broadcasted by the virtual machine 142 is received. In some embodiments, the discovery message can be formatted as a User Datagram Protocol (UDP) broadcast message. It should be appreciated however, that the discovery message can be any other type of message formatted according to any other type of communications protocol. If, in decision block 504, the ICD 112 determines that a broadcasted discovery message is received from the virtual machine 142, the method 504 advances to block 506. If, however, the ICD 112 determines instead that a broadcasted discovery message is not received from the virtual machine 142, the method 500 loops back to decision block 504 and the ICD 112 continues monitoring for receipt of a discovery message broadcasted by the virtual machine 142 (or any other virtual machine 140).

In block 506, the ICD 112 transmits connection information and identification data to the virtual machine 142 (or any other virtual machine 140) in response to receiving the broadcasted discovery message. In some embodiments, the connection information and identification data is transmitted to the virtual machine 142 via a wireless communication channel established between the ICD 112 and a wireless a wireless network interface of the IC server 130 accessible to the virtual machine 142 being initialized. The connection information and identification data can include data that uniquely identifies the ICD 112 (e.g., a unique name, a serial number, etc.) to the virtual machine 142 (block 508). The connection information and identification data can also include the IP and MAC addresses of the laboratory instrument 122 directly connected to the ICD 112 (block 510). Additionally, the connection information and identification data can also include the IP and MAC addresses of the wired and wireless communication interfaces of the ICD 112 (block 512 and block 514). It should be appreciated that the connection information and identification data can include any other type of data describing or associated with the ICD 112 and/or the laboratory instrument 122.

In decision block 516, the ICD 112 determines whether a WebSocket connection request message is received from the virtual machine 142. In some embodiments, the WebSocket connection request message may be generated by the virtual machine 142 during initialization. If, in decision block 516, the ICD 112 determines that a WebSocket connection request message is received, the method 500 advances to block 518. If, however, the ICD 112 determines instead that a WebSocket connection request message is not received, the method 500 loops back to decision block 516 and the ICD 112 continues monitoring for receipt of WebSocket connection request message from the virtual machine 142.

In block 518, the ICD 112 transmits a WebSocket response message to the virtual machine 142 that transmitted the original WebSocket connection request message. It should be appreciated that upon receipt of the WebSocket response message, the virtual machine 142 can establish a WebSocket connection with the ICD 112. In some embodiments, the WebSocket connection between the ICD 112 and the virtual machine 142 can be maintained while the virtual machine 142 is being executed by the IC server 130. In other embodiments, the WebSocket connection can be terminated or torn down after a predefined or reference time interval.

In block 520, the ICD 112 determines a forwarding strategy based on the IP and MAC addresses of the laboratory instrument 122 directly connected to the ICD 112 and the source IP and source MAC addresses included in the WebSocket connection request message received from the virtual machine 142. To do so, in some embodiments, the ICD 112 may determine to spoof the source MAC and/or source IP addresses of network packets to be forwarded to the laboratory instrument 122 with the MAC and/or IP addresses of the wired network interface of the ICD 112. In other embodiments, the ICD 112 may determine to replace the destination MAC and/or destination IP addresses of network packets to be forwarded to the virtual machine 142 with the MAC and/or IP addresses of the virtual network adapter of the virtual machine 142.

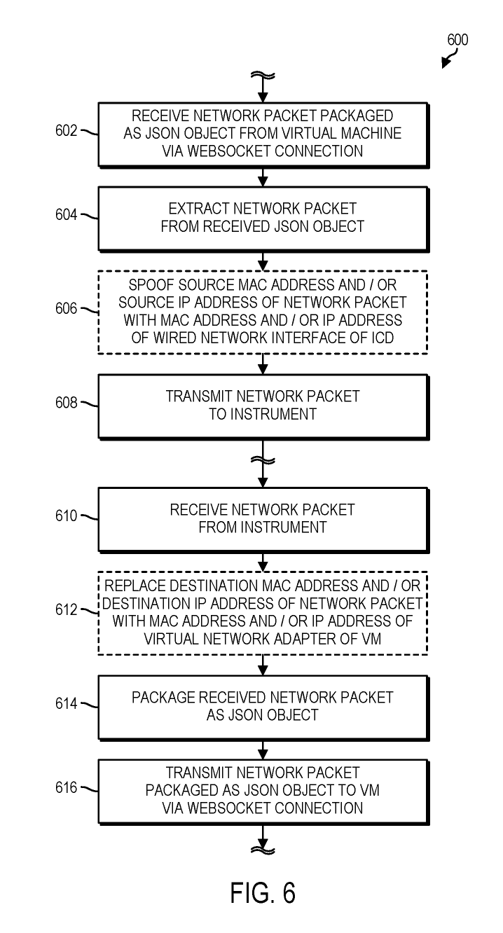

Referring now to FIG. 6, a method 600 that may be executed by the ICDs 110 for receiving and forwarding network packets between laboratory instruments 120 and virtual machines 140 is illustratively shown. For simplicity, the following description is directed to the receipt and forwarding of network packets between the laboratory instrument 122 and the virtual machine 142 by the ICD 112. It should be appreciated, however, that the method 600 can be executed by any other ICD 110 for receiving and forwarding network packets between any other laboratory instrument 120 and any other virtual machine 140. The method 600 begins with block 602 in which the ICD 112 receives a JSON object from the virtual machine 142 via a previously-established WebSocket connection. The JSON object includes a network packet generated by the virtual machine 142 and/or the instrument control and analysis software executing thereon. It should be appreciated that ICD 112 can also receive any other type of object from the virtual machine 142 that is suitable for containing or embedding a network packet. The network packet can include control data (e.g., test procedures, instrument settings, etc.) and/or monitoring requests received from the virtual machine 142. It should be appreciated that that the network packets can also include any other type of data generated and/or requested by the virtual machine 142 and/or the instrument control and analysis software executing thereon.

In block 604, the ICD 112 extracts the network packet from the received JSON object. In some embodiments, in block 606, the ICD 112 spoofs the source MAC address of the extracted network packet with the MAC address of the wired network interface of the ICD 112. Additionally or alternatively, in block 606, the ICD spoofs the source IP address of the extracted network packet with the IP address of the wired network interface of the ICD 112. In doing so, the laboratory instrument 122, upon receiving a spoofed network packet from the ICD 122, will send response network packets to the MAC and/or IP address of the wired network interface of the ICD 112.

In block 608, the ICD 112 forwards or otherwise transmits the received network packet to the laboratory instrument 122. In some embodiments, the ICD 112 forwards the network packet to the laboratory instrument 122 based on the forwarding strategy determined in blocks 420, 520 of the methods 400, 500 as described herein and illustratively shown in FIGS. 4 and 5.

In block 610, the ICD 112 receives a network packet from laboratory instrument 122. The network packet received from the laboratory instrument can include test/analysis data (e.g., test results data, progress data, environmental data, settings data, validation data, error data, etc.) and/or response data (e.g., instrument settings confirmation data, etc.). It should be appreciated that the network packets can also include any other type of data generated by the laboratory instrument 122. In some embodiments, in block 612, the ICD 112 replaces the destination MAC address of the received network packet with the MAC address of virtual network adapter of the virtual machine 142. Additionally or alternatively, in block 612, the ICD spoofs the destination IP address of the received network packet with the IP address of the virtual network adapter of the virtual machine 142.

In block 614, the ICD 112 packages or otherwise embeds the received network packet into a JSON object (or any other type of object suitable for containing or embedding a network packet). In block 616, the ICD 112 forwards, via the previously-established WebSocket connection, the JSON object including the received network packet to the virtual machine 142. In some embodiments, the ICD 112 forwards the received network packet to virtual machine 142 based on the forwarding strategy determined in blocks 420, 520 of the methods 400, 500 as described herein and illustratively shown in FIGS. 4 and 5. It should be appreciated that although the ICD 112 receives and forwards a network packet from the virtual machine 142 to the laboratory instrument 122 (blocks 602-608) before receiving and forwarding a network packet from the laboratory instrument 122 to the virtual machine 142 (blocks 610-616) in the illustrative embodiment, the ICD 112 may instead receive and forward a network packet to the laboratory instrument 122 before receiving and forwarding a network packet to the virtual machine 142 in other embodiments. That is, the order in which the network packets are received and forwarded by the ICD 112 can be reversed.

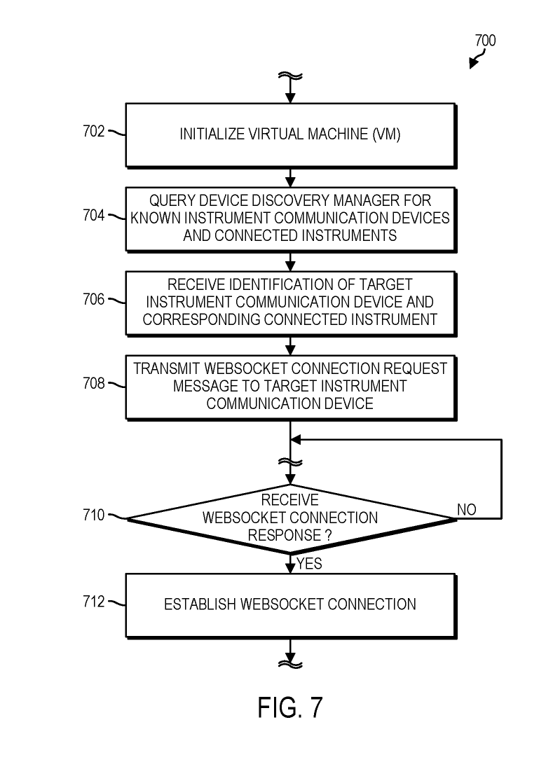

Referring now to FIG. 7, a method 700 that may be executed by the virtual machines 140 for initialization and establishment of WebSocket connections is illustratively shown. For simplicity, the following description is directed to the initialization of the virtual machine 142 and establishment of a WebSocket connection between the virtual machine 142 and the ICD 112 for enabling remote control and monitoring of the laboratory instrument 122. It should be appreciated, however, that the method 700 can be executed by any other virtual machine 140 for initialization and establishment of a WebSocket connection with any other ICD 110 to enable remote control and monitoring of any other laboratory instrument 120. The method 700 begins with block 702 in which the virtual machine 142 is initialized. The virtual machine 142 can be executed and initialized by the IC server 130 via any suitable boot module or initialization process. In some embodiments, the virtual machine 142 executes an operating system such as, for example, WINDOWS.

In block 704, the virtual machine 142 queries the device discovery manager 132 for connection information and identification data corresponding to known ICDs 110 and laboratory instruments 120 communicatively coupled thereto. To do so, in some embodiments, the virtual machine 142 and/or another component thereof (e.g., the operating system, a boot module, an initialization module, etc.) generates a connection information request message. The connection information request message can be transmitted or otherwise provided to the device discovery manager 132. In some embodiments, the virtual machine 142 generates and displays a list of known ICDs 110 and laboratory instruments 120 based on the connection information and identification data received from the device discovery manager 132 in response to the connection information request message.

In block 706, the virtual machine 142 receives user input data identifying the target ICD 112 and laboratory instrument 122 communicatively coupled thereto. In some embodiments, in response to receiving the user input data, the virtual machine 142 (or a component thereof) and/or the IC server 132 generates a virtual network adapter configured to access the laboratory instrument 122 via the ICD 112 communicatively coupled thereto. It should be appreciated that, in some embodiments, the virtual machine 142 may automatically determine (e.g., via machine learning, user preference matching, reference settings data, etc.) the target ICD 112 and laboratory instrument 120. Subsequently, in block 708, the virtual machine 142 transmits a WebSocket connection request message to the ICD 112 communicatively coupled to the laboratory instrument 122.

In decision block 710, the virtual machine 142 determines whether a WebSocket connection response message is received from the ICD 112. If, in decision block 710, the virtual machine 142 determines that a WebSocket connection response message is received from the ICD 112, the method 700 advances to block 712. If, however, the virtual machine 142 determines instead that a WebSocket connection response message is not received, the method 700 loops back to decision block 710 and the virtual machine 142 continues monitoring for receipt of WebSocket connection response message from the ICD 112.

In block 712, in response to determining that a WebSocket connection response message is received, the virtual machine 142 establishes a WebSocket connection with the ICD 112. In some embodiments, the WebSocket connection between the virtual machine 142 and the ICD 112 can be maintained while the virtual machine 142 is being executed by the IC server 130. In other embodiments, the WebSocket connection can be terminated or torn down after a predefined or reference time interval. As disclosed herein, the WebSocket connection can be configured to transmit network packets originating from the virtual machine 142 (or the software executing thereon) to the ICD 112 as JSON objects (or as any other type of objects). Additionally, or alternatively, the WebSocket connection can be configured to transmit network packets originally received from the laboratory instrument 122 to the virtual machine 122 (or the software executing thereon) as JSON objects (or as any other type of objects).

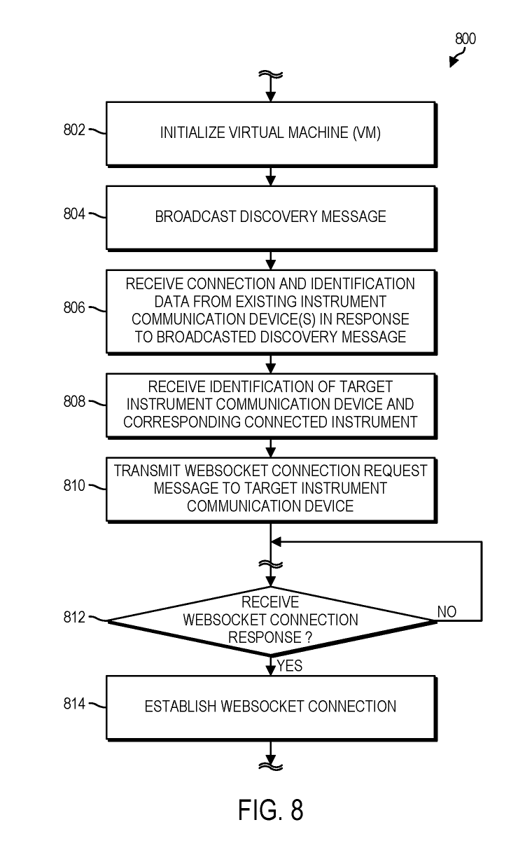

Referring now to FIG. 8, another method 800 that may be executed by the virtual machines 140 during initialization and establishment of WebSocket connections is illustratively shown. For simplicity, the following description is directed to initialization of the virtual machine 142 and establishment of a WebSocket connection between the virtual machine 142 and one or more of the ICDs 110. It should be appreciated, however, that the method 800 can be executed by any other virtual machine 140 for initialization and establishment of WebSocket connections. The method 800 begins with block 802 in which the virtual machine 142 is initialized. The virtual machine 142 can be executed and initialized by the IC server 130 via any suitable boot module or initialization process. In some embodiments, the virtual machine 142 executes an operating system such as, for example, WINDOWS.

In block 804, the virtual machine 142 broadcasts a discovery message over one or more wireless networks via one or more wireless network interfaces of the IC server 130. As described herein, each ICD 110, when active, is configured to respond to the discovery device message broadcasted by the virtual machine 142 (or any other virtual machine 140 from which the broadcast discovery message originates). In some embodiments, the discovery message can be formatted as a User Datagram Protocol (UDP) broadcast message. It should be appreciated however, that the discovery message can be any other type of message formatted according to any other type of communications protocol. In block 806, the virtual machine 142 receives connection information and identification data (e.g., Internet Protocol (IP) addresses, media access control (MAC) addresses, device identifiers, etc.) transmitted by one or more active ICDs 110 in response to the broadcasted discovery message. For example, in the illustrative embodiment, the virtual machine 142 receives connection information and identification data from the ICD 112

In block 808, the virtual machine 142 receives user input data identifying the particular laboratory instrument 120 and corresponding ICD 110 with which the virtual machine 142 (and/or any instrument monitoring and analysis software executing thereon) should communicate with. For example, in the illustrative embodiment, the virtual machine 142 receives user input data identifying the laboratory instrument 122 and the ICD 112 as the communication targets. It should be appreciated, however, that the virtual machine 142 can receive user input data identifying any other laboratory instrument 120 and ICD 110 in other embodiments. In some embodiments, in response to receiving the user input data, the virtual machine 142 (or a component thereof) and/or the IC server 132 generates a virtual network adapter configured to access the laboratory instrument 122 via the ICD 112 communicatively coupled thereto. It should be appreciated that, in some embodiments, the virtual machine 142 may automatically determine (e.g., via machine learning, user preference matching, reference settings data, etc.) the target ICD 112 and laboratory instrument 120. Subsequently, in block 810, the virtual machine 142 transmits a WebSocket connection request message to the ICD 112 communicatively coupled to the laboratory instrument 122.

In decision block 812, the virtual machine 142 determines whether a WebSocket connection response message is received from the ICD 112. If, in decision block 812, the virtual machine 142 determines that a WebSocket connection response message is received from the ICD 112, the method 800 advances to block 814. If, however, the virtual machine 142 determines instead that a WebSocket connection response message is not received, the method 800 loops back to decision block 812 and the virtual machine 142 continues monitoring for receipt of WebSocket connection response message from the ICD 112.

In block 814, in response to determining that a WebSocket connection response message is received, the virtual machine 142 establishes a WebSocket connection with the ICD 112. In some embodiments, the WebSocket connection between the virtual machine 142 and the ICD 112 can be maintained while the virtual machine 142 is being executed by the IC server 130. In other embodiments, the WebSocket connection can be terminated or torn down after a predefined or reference time interval. As disclosed herein, the WebSocket connection can be configured to transmit network packets originating from the virtual machine 142 (or the software executing thereon) to the ICD 112 as JSON objects (or as any other type of objects). Additionally, or alternatively, the WebSocket connection can be configured to transmit network packets originally received from the laboratory instrument 122 to the virtual machine 122 (or the software executing thereon) as JSON objects (or as any other type of objects).

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

1. A network communication apparatus for laboratory instruments according to one or more of the inventive principles as shown and described herein.

2. A network communication system for laboratory instruments according to one or more of the inventive principles as shown and described herein.

3. A method for enabling network communications between laboratory instruments and remote computing devices according to one or more of the inventive principles as shown and described herein.
